(19) United States
(12) Patent Application Publication
(10) Pub. No.: US 2025/0308020 A1
(43) Pub. Date: Oct. 2, 2025

(54) METHOD FOR DETERMINING A FOCUSING MEASURE OF A MICROSCOPIC IMAGE

(71) Applicant: EUROIMMUN Medizinische Labordiagnostika AG, Lübeck (DE)

(72) Inventors: Jens HOCKE, Lübeck (DE); Jens KRAUTH, Lübeck (DE); Stefan GERLACH, Lübeck (DE); Christopher KRAUSE, Lübeck (DE); Roland HAASE, Lübeck (DE); Melanie HAHN, Lübeck (DE); Jörn VOIGT, Lübeck (DE)

(73) Assignee: EUROIMMUN Medizinische Labordiagnostika AG, Lübeck (DE)

(21) Appl. No.: 19/089,358

(22) Filed: Mar. 25, 2025

(30) Foreign Application Priority Data
Mar. 26, 2024 (EP) 24166441.6

(51) Int. Cl. G06T 7/00

(52) U.S. Cl. CPC G06T 7/0012; G06T 2207/10056; G06T 2207/10064; G06T 2207/20084; G06T 2207/30024

(57) ABSTRACT

Proposed is a method for determining a focusing measure of a microscopic image, the microscopic image representing an image of a biological cellular substrate, the method comprising: providing the microscopic image, determining a gradient image on the basis of the microscopic image, processing image information from the gradient image and image information from the microscopic image by means of a neural network to determine the focusing measure, the focusing measure indicating quality of focusing in the microscopic image in relation to a cellular substrate plane of the cellular substrate.

In the field of diagnostic testing or medical diagnostic testing, it is a customary procedure to expose a biological cellular substrate to a patient sample, preferably a liquid patient sample in the form of dilute serum, in order to detect binding of specific antibodies of the patient sample to specific regions or specific antigens of the biological cellular substrate.

Here, the biological cellular substrate is first preferably incubated with the liquid patient sample, so that specific antibodies can bind to specific antigens of the cellular substrate. In a further step, incubation with a secondary antibody is then preferably performed, for example a so-called anti-human antibody and preferably one that has been lapebelled with a fluorescent dye, for example FITC. Such secondary antibodies can then bind to primary antibodies which have already bound to specific antigens of the substrate. When the substrate is then irradiated with excitation radiation, for example by means of light from a blue LED, the fluorescent dye is excited and then emits fluorescence radiation, preferably of a green colour. Using a microscope, a microscopic image of such fluorescence radiation may then be recorded. Therefore, the microscopic image may thus preferably be a fluorescence image, in particular an immunofluorescence image. The microscopic image is thus in particular an immunofluorescence image of a biological cellular substrate which was incubated with a patient sample, potentially comprising primary antibodies, and with secondary antibodies labelled with a fluorescent dye.

After such a microscopic image has been captured, detection of specific patterns or fluorescence patterns in the microscopic image may then preferably be carried out in order to provide relevant information to a treating physician, and on the basis of this information the physician can judge or estimate whether the patient has a specific clinical picture or not.

Such detection of fluorescence patterns may preferably be carried out by computer or by software, in particular software with artificial intelligence.

As an alternative to an immunofluorescence image, a microscopic image may, however, also be a so-called reflected light image of a biological cellular substrate. Here too, specific patterns may be detected by computer or software. Preferably, a microscopic image may be a transmitted light image of the biological cellular substrate.

Such a biological cellular substrate is preferably an organ section or a cell smear of biological cells.

Capturing of microscopic images of a biological substrate is well known from the prior art. There are also a variety of algorithms for detection of specific cell patterns or algorithms to establish whether specific cell patterns in the form of cell stains or preferably immunofluorescence patterns are present. Such algorithms are known, for example, from both EP4016082A1 and EP3971827A1 by the applicant.

Computer- or software-based detection of fluorescence patterns allow a degree of automation in determining a measure indicating that a specific fluorescence pattern is present. Such automation is gaining increasing importance in laboratory diagnostic testing in larger laboratory operations, especially because of efficiency.

The use of such software-based detection of a cell pattern requires that the corresponding microscopic image supplied to an algorithm or software for further processing be sufficiently well focused in relation to a cellular substrate plane of the cellular substrate.

FIG. 2 shows a biological cellular substrate SU which is positioned on or at a slide OT. The cellular substrate SU is substantially within a cellular substrate plane ZSE. Preferably, the cellular substrate SU is covered by means of a cover medium EM, above which is a cover glass DG. The cover medium EM and the cover glass DG are thus only preferably present. The biological cellular substrate is thus preferably on a slide, and particularly preferably, the cellular substrate is covered by a cover glass.

A microscopic image of the cellular substrate SU must then be recorded in such a way that the focusing plane of the microscope coincides with the cellular substrate plane ZSE or does not substantially deviate therefrom. Corresponding microscopy methods and devices are known, for example, from EP3642660A1 or EP3671309A1 by the applicant. Although the methods described in those documents are substantially sufficiently robust, problems or artefacts may occur when providing a cellular substrate SU, in particular due to a presence of an object P, which may be a particle. The particle P may be a hair, a speck of dust, particularly preferably a biscuit crumb, or, for example, a crystallized constituent of the fluorescent dye, for example an FITC crystal. In the preferred case of using a cover medium EM and cover glass DG, the object P may also be an air bubble.

The presence of an object P may cause a microscopy device to choose a focusing plane which does not coincide with the cellular substrate plane ZSE of the substrate SU; instead, because of the presence of the object P, it chooses the focusing plane in a plane ZP which is above the plane ZSE and which, for example, corresponds to the object P. Therefore, what may occur is that focusing of the microscopic image in relation to the cellular substrate SU is of insufficient quality, which can in particular also be referred to as a blurred microscopic image.

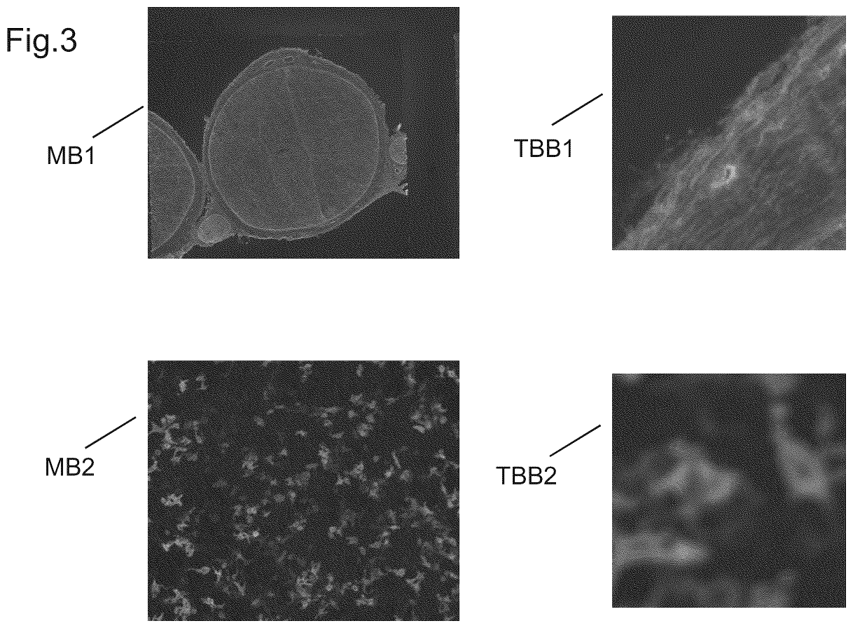

FIG. 3 shows a first microscopic image MB1 in which focusing of the microscopic image in relation to a cellular substrate plane is of sufficient quality. Also shown is a partial image region TBB1 of the microscopic image MB1, from which it can be seen that focusing is of sufficient quality.

A further, second microscopic image MB2 is likewise shown with a corresponding partial image region TBB2 under magnification. It can be seen here that focusing in the microscopic image is possibly of insufficient quality.

As a result, a person skilled in the art has the task of establishing whether focusing of a microscopic image in relation to a cellular substrate plane of a cellular substrate is of sufficient quality. Preferably, a decision can be made as to whether the corresponding microscopic image is to be processed in a subsequent step by a corresponding algorithm in order to detect a presence of specific patterns. If focusing of the microscopic image is already not of sufficient quality and this can be established, then preferably a decision can be made to avoid carrying out algorithm- or software-based analysis of the microscopic image for the purpose of detecting specific patterns, since there is a high probability of obtaining an erroneous result. Furthermore, information indicating that focusing of the microscopic image is of insufficient quality may preferably be used to infer that there are possibly conditions in the laboratory operation which allow objects, such as the object P from FIG. 2, to be introduced and that measures therefore be taken in order to avoid such error cases or artefacts.

Proposed therefore is a method according to the invention for determining a focusing measure of a microscopic image, the microscopic image representing an image of a biological cellular substrate and the method comprising the following steps: providing a microscopic image, determining a gradient image on the basis of the microscopic image, processing image information from the gradient image and image information from the microscopic image by means of a neural network to determine the focusing measure, the focusing measure indicating quality of focusing in the microscopic image in relation to a cellular substrate plane of the cellular substrate.

The focusing measure may preferably be a clear “Yes” or “No” statement, preference being given to a Boolean value from the set of values consisting of zero or one that indicates a “focused” or “non-focused” statement. Particularly preferably, the focusing measure may be a confidence measure as a scalar value from a value interval, and the confidence measure may in particular lie within a value interval from 0 to 1.

The gradient image is in particular a edge image, which is determined by filtering of the microscope by means of a gradient filter or an edge filter. The filter is in particular a two-dimensional filter, preferably a Sobel filter or a Laplacian of Gaussian filter.

One or more advantages of the method according to the invention that may be achieved will now be more particularly elucidated with explanation of individual aspects.

As elucidated above in relation to FIG. 2, a presence of an object P in a plane other than the cellular substrate plane may result in an error case being present, meaning that the microscopic image may be recorded such that a focal plane coincides with a plane ZP of the object P rather than with what is actually relevant, which is the cellular substrate plane ZSE. Known from the prior art for establishing that a microscopic image is focused or establishing to what extent it is focused are methods in which a gradient image is ascertained from a microscopic image and in which only image information from the gradient image is then evaluated in order to establish whether sufficiently large or strong gradient values are present in the gradient image. This means that the image is then usually correctly focused if gradient information in the gradient image assumes sufficiently strong values. However, such methods run the risk of possibly only taking into account gradient values in a gradient image that may arise as a result of focusing of the microscopic image on edge regions of an object P; see FIG. 2. If such a method with sole evaluation of a gradient image were to proceed, then a presence of such an object P could result in corresponding gradient values representing possible sharp edge regions also being present in a gradient image, since the boundary regions or edge regions of the object P would also generate corresponding gradient values of sufficient intensity in a gradient image. Therefore, in methods which only evaluate gradient image information, there is the risk of erroneously inferring from a microscopic image in which focusing has been effected on a plane ZP of an object P—see FIG. 2—that the image or microscopic image is sufficiently focused.

The method according to the invention proposed herein is, however, advantageous over the prior art, since the proposed method provides or allows an understanding of images by the neural network with regard to actual image information from the microscopic image. The neural network is in particular a neural network which has been pretrained on the basis of microscopic images and gradient images for the purpose of establishing whether there is quality of focusing in the microscopic image in relation to a cellular substrate plane of the cellular substrate.

Therefore, the method proposed herein takes into account both image information from the microscopic image and gradient information from the gradient image.

A joint evaluation of image information from the microscopic image and also image information from the gradient image effectively in place of evaluation of gradient information thus creates a constraint with regard to available image information from the microscopic image.

If, for example, there were to be a set of multiple microscopic images of the same substrate, the microscopic images having been recorded at different focusing planes, then the microscopic image that would be chosen according to the prior art would be the one whose gradient image has gradient information that is the most dominant and there would then have to be confidence in this decision. However, the proposed method allows presentation of a single microscopic image to the method and assessment thereof with respect to sufficient focusing, the neural network taking into account both gradient image information and microscopic image information.

Advantageous embodiments of the invention are subject matter of the dependent claims and are more particularly elucidated in the following description with reference in some cases to the figures.

The method further preferably comprises further steps of: identifying multiple partial gradient images of the gradient image, identifying multiple partial microscopic images of the microscopic image on the basis of the partial gradient images, a respective partial microscopic image of the microscopic image corresponding to a respective partial gradient image of the gradient image, and processing the partial gradient images and the partial microscopic images by means of a neural network to determine the focusing measure.

Preferably, the method further comprises: identifying multiple partial gradient images of the gradient image by identifying multiple image positions in the gradient image that indicate a high gradient presence.

Preferably carried out is selection of the partial gradient images from the gradient image on the basis of the identified image position.

The method further preferably comprises further steps of: dividing the gradient image into a set of gradient image regions according to a specified dividing scheme and identifying the multiple partial gradient images of the gradient image on the basis of the gradient image regions.

The method further preferably comprises: respectively processing respective partial image tuples by means of the neural network, a respective partial image tuple comprising a respective partial gradient image and a corresponding respective partial microscopic image.

Preferably, the focusing measure is determined on the basis of the respective processing results of the respective processing of the respective partial image tuples.

The method further preferably comprises: determining an adapted microscopic image on the basis of the microscopic image and processing image information from the gradient image, image information from the microscopic image and image information from the adapted microscopic image by means of a neural network to determine the focusing measure, the focusing measure indicating quality of focusing in the microscopic image in relation to a cellular substrate plane of the cellular substrate.

Preferably, the microscopic image is a fluorescence image, in particular an immunofluorescence image, of the biological cellular substrate or a reflected light image of the biological cellular substrate.

The microscopic image is in particular an immunofluorescence image of a biological cellular substrate which was incubated with a patient sample, potentially comprising primary antibodies, and with secondary antibodies labelled with a fluorescent dye.

Preferably, the biological cellular substrate is an organ section or a cell smear of biological cells.

Further proposed is a computation unit designed for executing the steps of: receiving a microscopic image representing an image of a biological cellular substrate, also determining a gradient image on the basis of the microscopic image, and processing image information from the gradient image and image information from the microscopic image by means of a neural network to determine a focusing measure, the focusing measure indicating quality of focusing in the microscopic image in relation to a cellular substrate plane of the cellular substrate.

Further proposed is a data network device comprising a data interface for receiving a microscopic image representing an image of a biological cellular substrate and comprising a computation unit according to the invention.

Further proposed is a computer program product comprising commands which, upon execution of the computer program product by a computer, cause said computer to carry out a method comprising: receiving a microscopic image representing an image of a biological cellular substrate, determining a gradient image on the basis of the microscopic image, and processing image information from the gradient image and image information from the microscopic image by means of a neural network to determine a focusing measure, the focusing measure indicating quality of focusing in the microscopic image in relation to a cellular substrate plane of the cellular substrate.

Further proposed is a data carrier signal which transmits the computer program product.

In the following, the invention will be more particularly elucidated in a specific embodiment, without limitation of the general inventive concept, with reference to the figures. In the figures:

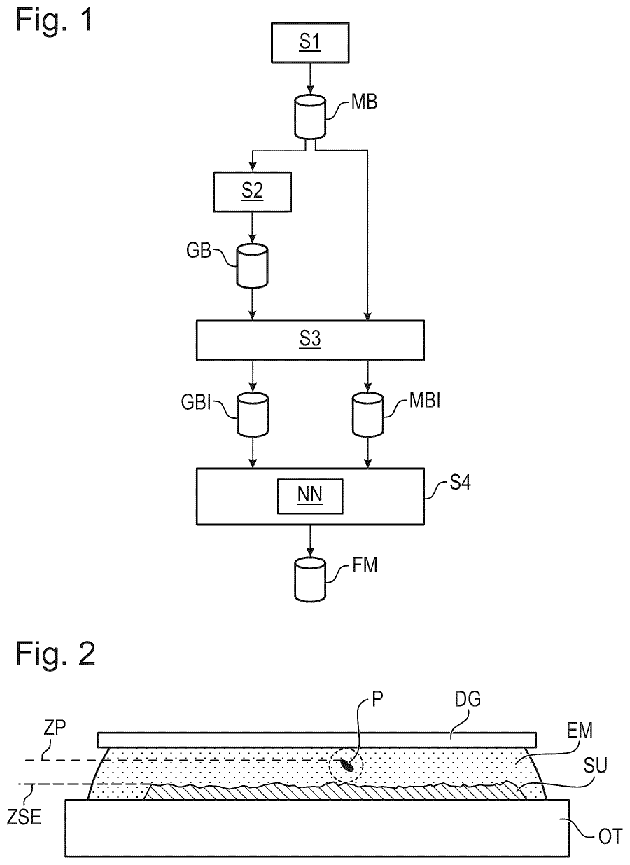

FIG. 1 shows steps of a preferred embodiment of the method according to the invention,

FIG. 2 shows a biological cellular substrate on a slide,

FIG. 3 shows example microscopic images and associated partial image regions,

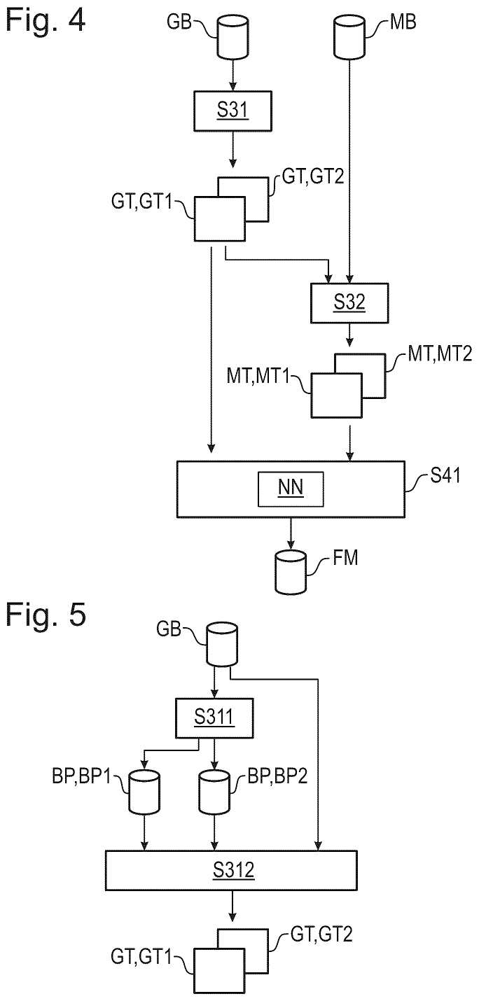

FIG. 4 shows preferred steps for determining partial gradient images of a gradient image and partial microscopic images of a microscopic image,

FIG. 5 shows preferred steps for identifying image positions in a gradient image,

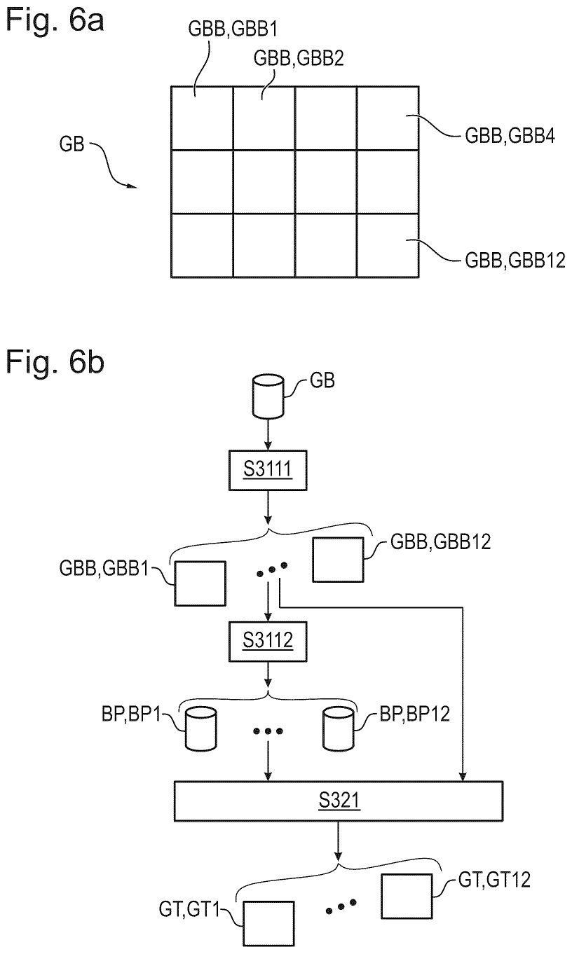

FIG. 6A shows a specified dividing scheme for dividing a gradient image,

FIG. 6B shows preferred steps for identifying partial gradient images,

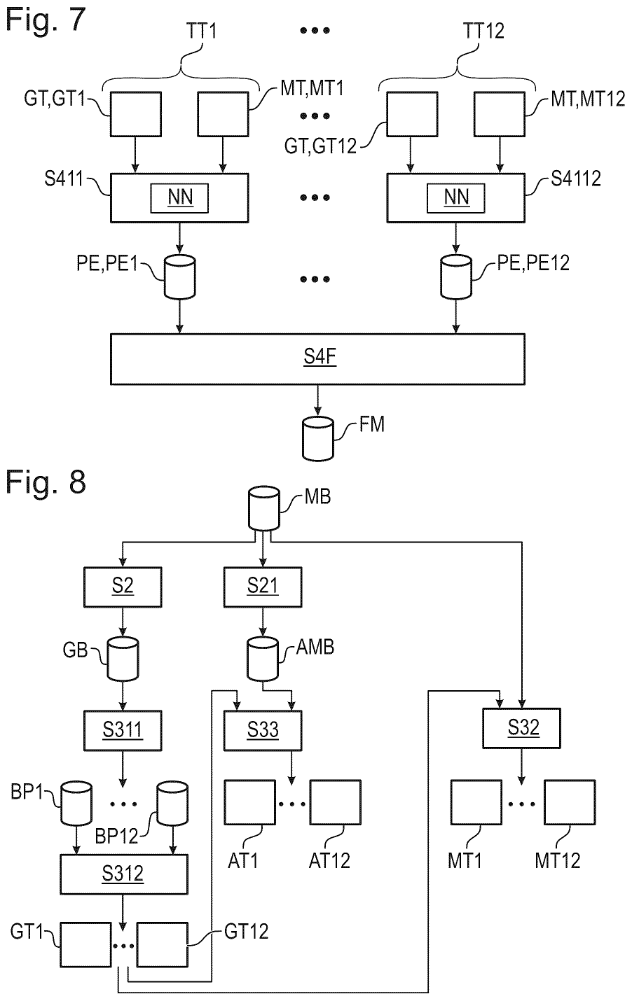

FIG. 7 shows preferred steps for processing partial image tuples by means of a neural network,

FIG. 8 shows preferred steps for determining an adapted microscopic image and processing image information from a gradient image, a microscopic image and an adapted microscopic image to determine a focusing measure,

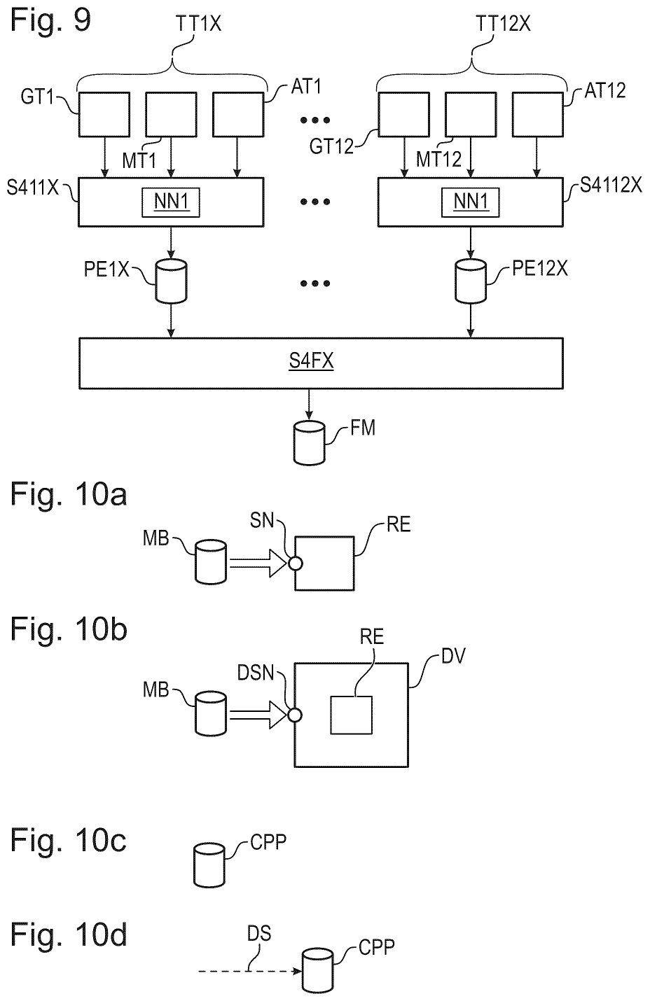

FIG. 9 shows preferred steps for processing partial image tuples, a partial image tuple comprising a partial gradient image, a partial microscopic image and a partial image of an adapted microscopic image,

FIG. 10A shows a proposed computation unit,

FIG. 10B shows a proposed data network device,

FIG. 10C shows a proposed computer program product,

FIG. 10D shows a proposed data carrier signal,

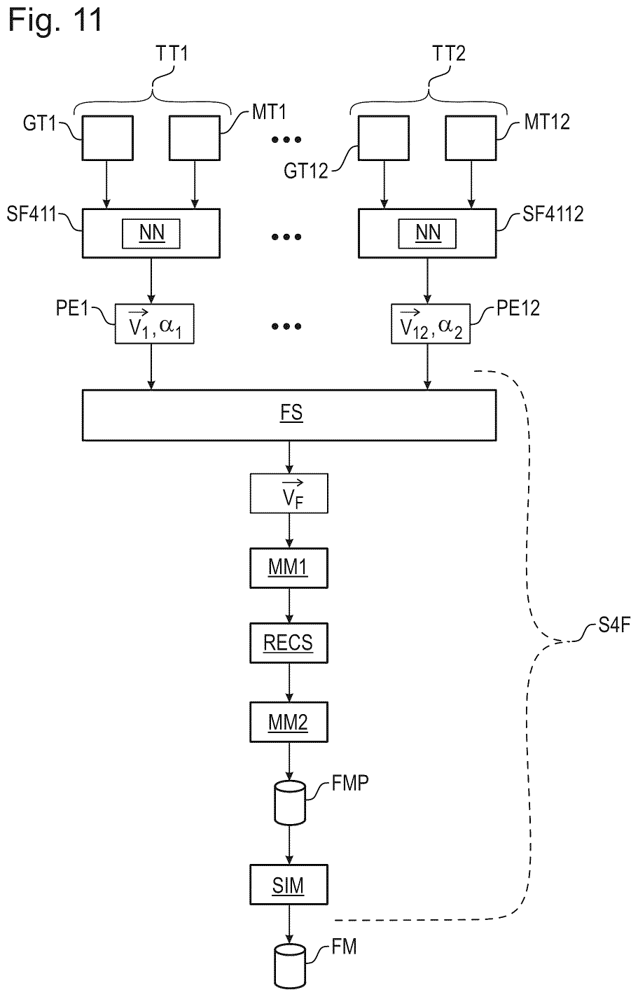

FIG. 11 shows preferred steps for determining a focusing measure,

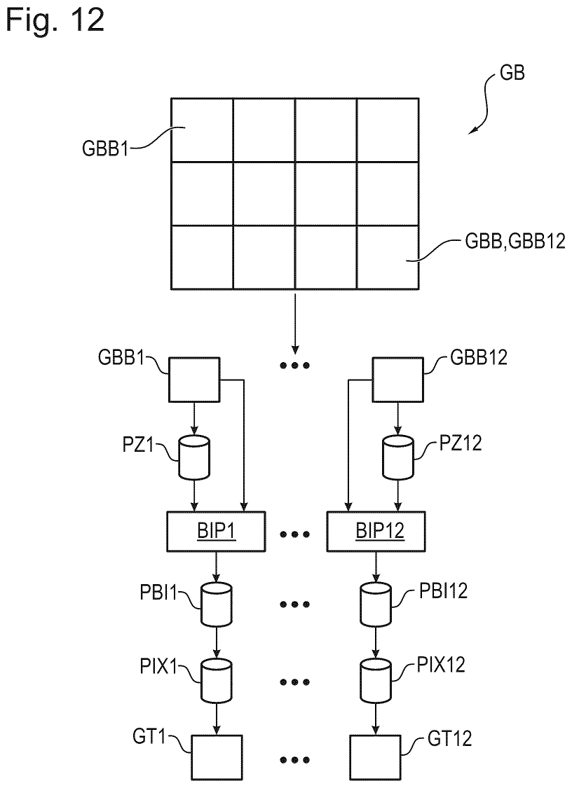

FIG. 12 shows preferred steps for determining partial gradient images,

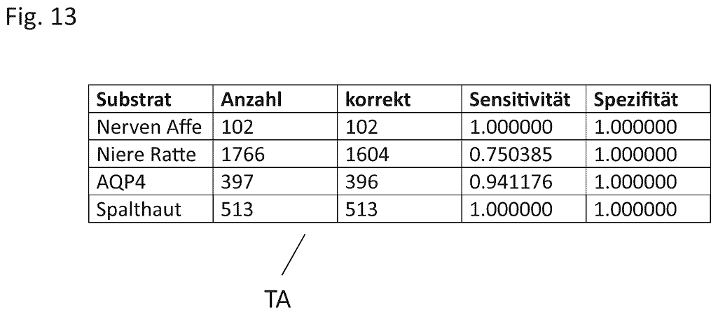

FIG. 13 shows experimental results,

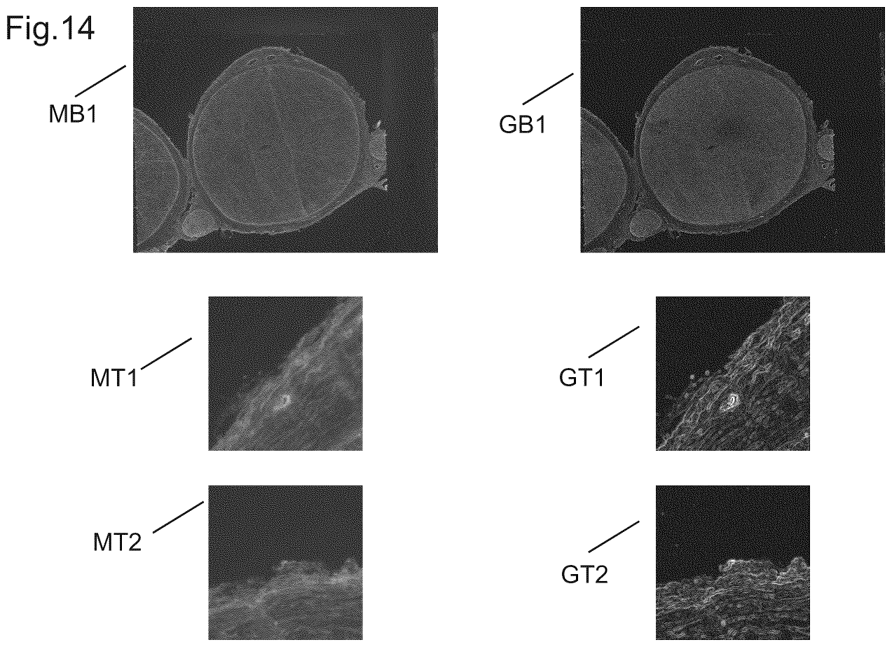

FIG. 14 shows example microscopic images and associated partial image regions.

FIG. 1 shows a preferred embodiment of a method according to the invention for determining a focusing measure FM of a microscopic image MB.

In a step S1, the microscopic image is provided. In a step S2, a gradient image GB is ascertained on the basis of the microscopic image MB. This is preferably done using a Sobel filter.

Such a filter may preferably be referred to as a gradient filter or as an edge filter.

In a step S3, image information from the gradient image GBI and image information from the microscopic image MBI are then extracted.

In a step S4, image information GBI from the gradient image GB and image information MBI from the microscopic image MB are then processed using a neural network NN to determine the focusing measure FM, the focusing measure indicating quality of focusing in the microscopic image in relation to a cellular substrate plane of the cellular substrate.

As already explained above, the method according to the invention proposed herein is advantageous because it is not only information from a gradient image GBI that is evaluated by the neural network, but precisely also information from the microscopic image MBI at the same time, and so the neural network NN has in particular an understanding of images with regard to actual image information from the microscopic image MB.

FIG. 4 shows further preferred steps for determining the focusing measure FM.

A step S31 comprises identifying partial gradient images GT of the gradient image GB. Preferably, two partial gradient images GT1, GT2 are determined. On the basis of the partial gradient images GT, multiple partial microscopic images MT of the microscopic image MB are then identified in a step S32. Preferably, two partial microscopic images MT1, MT2 are identified here as well.

The partial gradient images GT can be understood as gradient image information or image information from the gradient image GBI from FIG. 1. The partial microscopic images MT can be understood as image information from the microscopic image MBI from FIG. 1.

A respective partial microscopic image MT1 of the microscopic image MB corresponds to a respective partial gradient image GT1 of the gradient image GB. The same also applies to correspondence of the partial microscopic image MT2 to the partial gradient image GT2.

It can be noted in particular that steps S31 and S32 result in identification and selection of multiple partial gradient images GT from the gradient image GB and also identification and selection of multiple partial microscopic images MT from the microscopic image MB.

In step S41, processing of the partial gradient images GT and the partial microscopic images MT is then performed by means of the neural network NN to determine the focusing measure FM.

The preferred steps from FIG. 4 have the advantage of allowing detection of image regions having strong differences in intensity by looking at the gradient image information. It is especially advantageous here that the neural network NN need not process all image information from the microscopic image and from the entire gradient image; instead, it only has to process specific identified or selected image information from identified and selected partial gradient images GT and partial microscopic images MT. A very high degree of complexity of the neural network NN would be required to evaluate all image information from an entire microscopic image and an entire gradient image. Complexity of the neural network NN is distinctly reduced by choosing or identifying and selecting specific partial images of the gradient image and the microscopic image. In particular, a relevant subset of image information, given by the partial gradient images GT and the partial microscopic images MT, can be subjected to processing or evaluation by the neural network NN to determine the focusing measure FM.

By way of example, FIG. 14 shows once again the microscopic image MB1 from FIG. 3 and an associated gradient image GB1. Furthermore, FIG. 14 shows identified and selected partial gradient images GT1, GT2, which were selected from the gradient image GB1 and are shown under magnification. Furthermore, FIG. 14 shows corresponding respective partial microscopic images MT1, MT2. As can be seen from FIG. 14, both the microscopic image MB1 and the gradient image GB1 have image regions which are essentially dark and are referred to as so-called background. Such image regions have little information regarding sufficient quality of focusing of the microscopic image.

Since, according to a particular embodiment, not all image information from the microscopic image MB, MB1 and the gradient image GB, GB1 are used in the method proposed herein, but precisely only specific partial images GT1, GT2 of the gradient image and corresponding partial images MT1, MT2 of the microscopic image, the neural network can focus on the partial image regions that provide relevant image information. This can bring about an increase in reliability or robustness, in particular performance, of the neural network for determining the focusing measure.

FIG. 5 shows further preferred steps for identifying partial gradient images. The gradient image GB is analysed in a step S311. This involves identifying and in particular selecting the multiple partial gradient images GT by identifying multiple image positions in the gradient image GB that indicate a high gradient presence. Preferably, this is followed by selecting the partial gradient images GT from the gradient image GB in a step S312 on the basis of the identified image positions BP.

Referring to the example from FIG. 14, it is possible to choose image positions in the gradient image that have a high gradient presence, in this case bright image intensities. As a result of identifying corresponding image positions in the gradient image GB1, the partial gradient images GT1 and GT2 can then be identified and extracted or selected.

This considering of image positions having a high gradient presence is therefore advantageous, since only partial gradient images and corresponding partial microscopic images that potentially represent a subset of image information from the entire images in the form of the gradient image GB1 and the microscopic image MB1 are subjected to analysis by the neural network, the identified and selected partial images being precisely most suitable for ascertaining a degree of sharpness or a focusing measure of the microscopic image MB1.

FIG. 6A shows a specified dividing scheme, in particular a fixed dividing scheme, for dividing the gradient image GB into a set of gradient image regions GBB. According to the example shown here, use is made of multiple gradient image regions GBB in the form of the gradient image regions GBB1 to GBB12, with the number of gradient image regions GBB being twelve by way of example.

FIG. 6B further shows further preferred steps for identifying the partial gradient images GT. This involves, in a step S3111, the dividing of the gradient image GB into a set of gradient image regions GBB as elucidated above, for twelve different gradient image regions GBB1 to GBB12 in this example. Such gradient image regions GBB can also be referred to as so-called patches.

This is followed, in a step S3112, by carrying out for a respective gradient image region GBB a respective identification of a respective corresponding image position BP which indicates a high gradient presence. Therefore, for the example gradient image regions GBB1 to GBB12 here, corresponding image positions BP1 to BP12 are respectively identified.

On the basis of a respective image position BP, a respective identification and in particular selection of a respective partial gradient image GT for a respective gradient image region GBB is carried out in a step S321. Without restricting generality, what is thus carried out in this example is that a partial gradient image GT1 is identified in and selected from the gradient image region GBB1. The same is carried out for determining the partial gradient image GT12 on the basis of the gradient image region GBB12.

The fixed dividing scheme is in particular a fixed spatial dividing scheme for dividing the gradient image GB into gradient image regions GBB. What is thus carried out in particular is identification of the multiple partial gradient images GT of the gradient image GB on the basis of the gradient image regions GBB, and preferably a respective partial gradient image GT1 is identified and in particular selected on the basis of a respective gradient image region GBB1.

The procedure from FIG. 6B shown here is especially advantageous, since division of the gradient image into gradient image regions and respective identification of the partial gradient images in each case in the respective gradient image regions allows, or preferably forces, a spatial distribution of the partial gradient images across the gradient image. This avoids domination by a specific image region of the gradient image having strong image sharpness and thus identification and selection of partial gradient images from such an image region. For example, if a dominant particle, such as preferably a biscuit crumb from a biscuit eaten by a medical assistant in the laboratory area, were to be present on the biological substrate, then such an object or particle could bring about particularly strong gradient image information or a particularly strong gradient image intensity in the gradient image that might be stronger than any other gradient image intensity caused by the substrate itself. Since it is not only a very specific area of the object or particle, possibly erroneously identified here, that is to be chosen later by way of the partial gradient images and corresponding partial microscopic images for subsequent feeding thereof to the neural network, but it is precisely also image information from partial gradient images and partial microscopic images from other areas of the gradient image and the microscopic image that are to be analysed by the neural network, then the division of the gradient image into a set of gradient image regions to determine the partial gradient images, as proposed herein, is advantageous. Such a patch structure ensures that partial image information from different image regions is taken into account in an analysis by the neural network to ascertain the focusing measure.

FIG. 7 shows further preferred steps. Preferably, the neural network NN carries out respective processing of respective partial image tuples, a respective partial image tuple comprising a respective partial gradient image and a corresponding respective partial microscopic image. This processing is in particular respective separate processing of respective partial image tuples by the same neural network NN in each case.

In relation to this, FIG. 7 shows a partial image tuple TT1 comprising the partial gradient image GT1 and the partial microscopic image MT1. In a step S411, the partial gradient image GT1 and the partial microscopic image MT1 of the partial image tuple TT1 are simultaneously processed by the neural network NN. Separately, in a step S4112, the same neural network carries out processing of the partial gradient image GT12 and the partial microscopic image MT12 of the partial image tuple TT12.

The processing of the partial image tuple TT1 yields a processing result PE1. Processing of the partial image tuple TT12 yields a processing result PE12. The two form processing results PE.

On the basis of the respective processing results PE1, . . . , PE12 of the respective partial image tuples TT1, . . . , TT12, the focusing measure FM is then determined at a step S4F.

The procedure proposed herein is advantageous, since the neural network can be specially trained to simultaneously process only the image information from the partial gradient image and the partial microscopic image of a single partial image tuple. This can reduce in particular the complexity of the neural network NN, since not all partial gradient images GT1, . . . , GT12 and not all partial microscopic images MT1, . . . , MT12 have to be simultaneously processed by the neural network NN. A partial gradient image and a partial microscopic image of a partial image tuple are thus processed in particular together and in particular simultaneously by the neural network NN.

Such simultaneous processing of a partial gradient image and a partial microscopic image of a partial image tuple effectively guides the neural network NN by means of the gradient information from the partial gradient image, so that in particular image structures present at image positions having significant gradient intensity values in the partial gradient image are focused on in the partial microscopic image of the partial image tuple.

Preferably, further carried out is determination of an adapted microscopic image on the basis of the microscopic image. In relation to this, FIG. 8 shows a step S21 for generating an adapted microscopic image AMB on the basis of the microscopic image MB. For this purpose, for example, the microscopic image MB may be adjusted in terms of its intensity values in terms of its brightness or intensity using a scaling factor.

FIG. 8 also shows the above-described step S2 for determining the gradient image GB and the above-described step S311 in relation to FIG. 5 for identifying image positions BP1, . . . , BP12, on the basis of which partial gradient images GT1, . . . , GT12 can then be identified and selected in step S312. Furthermore, FIG. 8 shows step S32, which has already been described in relation to FIG. 4 and in which, on the basis of the partial gradient images GT1, . . . , GT12, respective corresponding partial microscopic images MT1, . . . , MT12 can be identified and selected. On the basis of the partial gradient images GT1, . . . , GT12, what is then carried out in a step S33, analogously to step S32, is identification and selection from the adapted microscopic image AMB of corresponding partial images of the adapted microscopic image AT1, . . . , AT12. Said partial images of the adapted microscopic image AT1, . . . , AT12 can then thus be understood as image information from the adapted microscopic image.

FIG. 9 shows processing of image information from the gradient image, image information from the microscopic image and image information from the adapted microscopic image by means of the neural network NN to determine the focusing measure FM. This involves carrying out processing of respective partial image tuples TT1X, . . . , TT12X that differ from the partial image tuples TT1X, . . . , TT12X from FIG. 7 in that a respective partial image tuple TT1X, TT12X not only comprises a partial gradient image GT1 or GT12 and a respective partial microscopic image MT1 or MT12, but furthermore also comprises a respective partial image of the adapted microscopic image AT1 or AT12.

In respective separate processing steps S411X, . . . , S4112X, what can then be carried out is ascertaining of respective processing results PE1X, . . . , PE12X, on the basis of which the focusing measure FM can then be determined in a final step SF4X.

The procedure proposed herein has the advantage of allowing a more robust method for determining the focusing measure FM, since further image information from the adapted microscopic image is taken into account in the analysis by the neural network NN.

As mentioned above, the microscopic image is preferably an immunofluorescence image. The method proposed herein is especially advantageous for immunofluorescence images, since such immunofluorescence images may show only little binding or no binding of antibodies to antigens and thus also only little binding or no binding of a fluorescent dye to the biological substrate, such that only a low image intensity is present in the immunofluorescence image as the microscopic image. The method proposed herein for assessing the quality of a focusing measure of the microscopic image is advantageous in such a case of an immunofluorescence image in a so-called “negative case” (low image intensity), since classic image processing methods are commonly not performant at low image intensities for sufficient detection of image structures in the microscopic image or the gradient image. Here, the use of a neural network for joint analysis of the microscopic image and its image information and of the gradient image and its image information is more reliable.

Explained in relation to FIGS. 6A and 6B was processing for determination of the partial gradient images GT using a specified dividing scheme for dividing the gradient image GB.

FIG. 12 shows further details in relation to this. The gradient image GB is divided into corresponding gradient image regions GBB1, . . . , GBB12, which can also be referred to as so-called patches, using the specific dividing scheme. For a gradient image region GBB1, what is then ascertained is a corresponding percentile value PZ1 of the image intensity values in the gradient image region GBB1. The same is done for the other gradient image regions, such as the gradient image region GBB12, to determine a corresponding percentile value PZ12.

A gradient image region GBB1 may then be converted into a binary image region BIP1 using the corresponding percentile value PZ1 as a threshold for a 0/1 decision. A corresponding binary image region BIP1 may then be analysed in such a way that all pixel positions or pixels for which the corresponding value of the binary image BIP1 assumes the value 1 are transferred to a set of pixel positions PBIP1. The same may be done for a respective binary image region, such as BIP12, to obtain pixel sets or pixel positions of a corresponding set PBIP12.

From a set of pixel positions PBIP1, what may then be chosen at random is a single pixel with a pixel position PIX1, and so what has been chosen is a single pixel position that lies in the corresponding previously formed gradient image region GBB1. Around such a pixel position PIX1, what may then be formed is a corresponding cutout or region of interest ROI as a partial gradient image in order to select a corresponding partial gradient image GT1 from the corresponding gradient image region GBB1 or the gradient image GB or to identify a corresponding partial gradient image GT1 in the gradient image GB.

The same may also be done for another gradient image region GBB12 for which a binary image BIP12 is ascertained with a corresponding set of pixels PBIP12 which assume the value 1, such that a single pixel or single pixel position PIX12 may be chosen at random from the pixel position set PBIP12. On the basis of the presently identified text or the pixel position PIX12, a corresponding region of interest may then be placed around it for identification and selection of the partial gradient image GT12 from the gradient image region GBB12 or the gradient image GB.

FIG. 11 shows preferably performed steps for determining the focusing measure FM on the basis of the partial image tuples TT1, . . . , TT12 for an example of twelve partial image tuples or twelve partial image regions in the gradient image and the microscopic image. As already mentioned above in relation to FIG. 7, a partial image tuple TT1 is processed by means of a neural network NN in order to determine a processing result PE1. The same is separately carried out for other partial image tuples, such as the partial image tuple TT12, in order to determine a corresponding processing result PE12.

The neural network NN is preferably a so-called mobile net in the form of a neural network having an encoding path.

The processing of the partial image tuples TT1, . . . , TT12 shown here preferably represents so-called multiple instance learning.

The processing result PE1 is preferably given by two variables: first a vector

$$\vec{{v}_{1}} = {[ … ]}^{N}$$

of dimensionality N as a so-called encoding vector and a scalar value
α₁
   which is preferably in a value range of 0-1.

The scalar value α₁ may preferably indicate a significance of the vector \vec{v₁}=[ . . . ]^{N}. Preferably, the dimensionality N of the vector \vec{v₁}=[ . . . ]^{N} chosen is the value N=128.

A corresponding processing result PE12 then likewise has a vector

$$\vec{{v}_{12}} = {[ … ]}^{N}$$

and a scalar value
α₁₂
   in an corresponding manner.

In an example in which twelve partial gradient images are extracted from one gradient image, such that twelve partial image tuples are respectively separately processed, each partial gradient image and also each tuple and each processing result is identified by a corresponding index p=1 . . . P, where P=12.

Step SF4, as shown in relation to FIG. 7, for processing of the respective processing results PE1, . . . , PE12 for the purpose of determining the focusing measure FM will now be explained in more detail in a preferred embodiment.

In a fusion step FS, the processing results are superpositioned according to

$$\vec{{v}_{F}} = {\sum }_{p = 1}^{p} {α}_{p} \cdot \vec{{v}_{p}}$$

Then in a step MM1, multiplication of the processing or fusion result

$$\vec{{v}_{F}} = {\sum }_{p = 1}^{P} {α}_{p} \cdot \vec{{v}_{p}}$$

may be carried out by multiplying
\vec{v_{F}} by a matrix W₁.

In a subsequent processing step RECS, a rect function may be applied to the resultant values.

In a further step MM2, multiplication by a matrix

W₂ may in turn be carried out, which can lead to a scalar value FMP. Said scalar value FMP may then be processed by applying a sigmoid function in a step SIM to obtain the focusing measure FM such that the focusing measure is within a value range from 0 to 1.

FIG. 10A shows a proposed computation unit according to a preferred embodiment. The computation unit RE comprises a data interface SN designed for receiving a microscopic image. The computation unit RE is further designed for determining a gradient image on the basis of the microscopic image MB and for processing image information from the gradient image and the microscopic image by means of a neural network to determine the focusing measure.

FIG. 10B shows a preferred embodiment of a data network device DV comprising a data interface DSN for receiving a microscopic image MB. The data network device DV comprises a computation unit RE.

Further proposed according to FIG. 10C is a computer program product comprising commands which, upon execution of the computer program product by a computer, cause said computer to carry out a method comprising: receiving a microscopic image representing an image of a biological cellular substrate, determining a gradient image on the basis of the microscopic image, and processing image information from the gradient image and image information from the microscopic image by means of a neural network to determine a focusing measure, the focusing measure indicating quality of focusing in the microscopic image in relation to a cellular substrate plane of the cellular substrate.

Further proposed according to FIG. 10D is a data carrier signal DS which transmits the computer program product CPP.

The features disclosed in the description above, the claims and the drawings may be relevant either individually or in any combination for realization of exemplary embodiments in their various configurations and—unless indicated otherwise in the description—may be combined with each other as desired.

Although some aspects have been described in connection with a device, it is understood that said aspects are also a description of the corresponding method, and so a block or a component of a device can also be understood as a corresponding method step or as a feature of a method step. By analogy, aspects which have been described in connection with a method step or as a method step are also a description of a corresponding block or detail or feature of a corresponding device.

Depending on the specific requirements for implementation, exemplary embodiments of the invention may be hardware-implemented or software-implemented. Implementation may be achieved using a digital storage medium, for example a floppy disk, a DVD, a Blu-ray Disc, a CD, a ROM, a PROM, an EPROM, an EEPROM or a FLASH memory, a hard disk or some other magnetic or optical memory, which stores electronically readable control signals which cooperate or can cooperate with a programmable hardware component such that the method in question is carried out.

A programmable hardware component, such as in particular a computation unit, may be formed by a processor, a central processing unit (CPU), a graphics processing unit (GPU), a computer, a computer system, an application-specific integrated circuit (ASIC), an integrated circuit (IC), a system on a chip (SOC), a programmable logic element or a field-programmable gate array with a microprocessor (FPGA).

The digital storage medium may therefore be machine-readable or computer-readable. Some exemplary embodiments thus comprise a data carrier having electronically readable control signals capable of cooperating with a programmable computer system or a programmable hardware component such that one of the methods described herein is carried out. One exemplary embodiment is therefore a data carrier (or a digital storage medium or a computer-readable medium) on which the program for carrying out one of the methods described herein has been recorded.

In general, exemplary embodiments of the present invention may be implemented as a program, firmware, computer program or computer program product containing program code or as data, the program code or the data being effective in carrying out one of the methods when the program runs on a processor or a programmable hardware component. The program code or the data may also be stored, for example, on a machine-readable carrier or data carrier. The program code or the data may be available, inter alia, as source code, machine code or bytecode, or as any other intermediate language.

Furthermore, a further exemplary embodiment is a data stream, a signal sequence or a sequence of signals that forms the program for carrying out one of the methods described herein. The data stream, the signal sequence or the sequence of signals may be configured, for example, to be transferred over a data communication connection, for example over the Internet or some other network. Exemplary embodiments are thus also data-representing signal sequences suitable for transmission over a network or a data communication connection, the data forming the program.

A program according to one exemplary embodiment may implement one of the methods while it is being carried out by, for example, reading memory locations or writing one or more items of data to said memory locations, thereby possibly causing switching operations or other operations in transistor structures, in amplifier structures or in other components which are electrical, optical or magnetic or work according to some other operating principle. Accordingly, by reading a memory location, a program can acquire, determine or measure data, values, sensor values or other information. Therefore, by reading one or more memory locations, a program can acquire, determine or measure variables, values, measured variables and other information, and by writing to one or more memory locations, it can bring about, cause or carry out an action and control other equipment, machines and components.

### Results

FIG. 13 shows different processing results for different substrates. The results are shown in the table TA. Neuronal networks were trained on the basis of immunofluorescence images.

For a biological substrate in the form of monkey nerves, 102 test images were evaluated with respect to quality of focusing of the microscopic images or immunofluorescence images. Here, all 102 images were assessed correctly with regard to focusing being present or not being present.

The measure of sensitivity shown here is an evaluation where the sensitivity is high when blurred images or poorly produced images were also actually recognized as poor focusing. The sensitivity here for this substrate is 1.0.

The specificity shown here are cases in which sharp images or focused images were also recognized as focused or sharp. The specificity here for this substrate is 1.0.

For biological substrates showing a rat kidney in an immunofluorescence image, 1766 test images were evaluated as immunofluorescence images or microscopic images. Here, 1604 images were assessed correctly. The sensitivity here was 0.750385 and the specificity 1.0.

For biological substrates comprising the protein aquaporin-4, 397 immunofluorescence images were evaluated, and 396 of these images were assessed correctly. The sensitivity here was 0.941176. The specificity here was 1.0.

For biological substrates showing split skin, 513 test images were analysed and all 513 images were assessed correctly, meaning that the sensitivity and the specificity were both 1.0.

1. Method for determining a focusing measure of a microscopic image,
the microscopic image (MB) representing an image of a biological cellular substrate, the method comprising
providing the microscopic image (MB),
determining a gradient image (GB) on the basis of the microscopic image (MB),
processing image information (GBI) from the gradient image (GB) and image information (MBI) from the microscopic image (MB) by means of a neural network (NN) to determine the focusing measure (FM), the focusing measure (FM) indicating quality of focusing in the microscopic image (MB) in relation to a cellular substrate plane (ZSE) of the cellular substrate (SU).

2. Method according to claim 1,
further comprising
identifying multiple partial gradient images (GT) of the gradient image (GB),
identifying multiple partial microscopic images (MT) of the microscopic image (MB) on the basis of the partial gradient images (GT), a respective partial microscopic image (MT1) of the microscopic image (MB) corresponding to a respective partial gradient image (GT1) of the gradient image (GB),
processing the partial gradient images (GT) and the partial microscopic images (MT) by means of a neural network (NN) to determine the focusing measure (FM).

3. Method according to claim 2,
further comprising
identifying multiple partial gradient images (GT) of the gradient image (GB) by identifying multiple image positions (BP) in the gradient image (GB) that indicate a high gradient presence.

4. Method according to claim 2,
further comprising
dividing the gradient image (GB) into a set of gradient image regions (GBB) according to a specified dividing scheme,
identifying the multiple partial gradient images (GT) of the gradient image (GB) on the basis of the gradient image regions (GBB).

5. Method according to claim 2,
further comprising
respectively processing respective partial image tuples (TT) by means of the neural network (NN),
a respective partial image tuple (TT1) comprising a respective partial gradient image (GT1) and a corresponding respective partial microscopic image (MT1).

6. Method according to claim 5,
wherein the focusing measure (FM) is determined on the basis of the respective processing results (PE) of the respective processing of the respective partial image tuples (TT).

7. Method according to claim 1,
further comprising
determining an adapted microscopic image (AMB) on the basis of the microscopic image (MB),
processing image information (GBI) from the gradient image (GB), image information (MBI) from the microscopic image (MB) and image information from the adapted microscopic image (AMB) by means of a neural network (NN) to determine the focusing measure (FM), the focusing measure indicating quality of focusing in the microscopic image in relation to a cellular substrate plane of the cellular substrate.

8. Method according to claim 1,
wherein the microscopic image (MB) is a fluorescence image, in particular an immunofluorescence image, of the biological cellular substrate (SU) or a reflected light image of the biological cellular substrate (SU).

9. Method according to claim 1,
wherein the biological cellular substrate (SU) is an organ section or a cell smear of biological cells.

10. Computation unit (RE) designed for
receiving a microscopic image (MB) representing an image of a biological cellular substrate,
also determining a gradient image (GB) on the basis of the microscopic image (MB),
and processing image information (GBI) from the gradient image (GB) and image information (MBI) from the microscopic image (MB) by means of a neural network (NN) to determine a focusing measure (FM), the focusing measure indicating quality of focusing in the microscopic image in relation to a cellular substrate plane of the cellular substrate.

11. Data network device (DV)
comprising a data interface (DSN) for receiving a microscopic image (MB) representing an image of a biological cellular substrate,
characterized by a computation unit (RE) according to claim 10.

12. Computer program product
comprising commands which, upon execution of the computer program product (CPP) by a computer, cause said computer to carry out a method comprising
receiving a microscopic image (MB) representing an image of a biological cellular substrate,
determining a gradient image (GB) on the basis of the microscopic image (MB),
processing image information (GBI) from the gradient image (GB) and image information (MBI) from the microscopic image (MB) by means of a neural network (NN) to determine a focusing measure (FM), the focusing measure indicating quality of focusing in the microscopic image (MB) in relation to a cellular substrate plane (ZSE) of the cellular substrate (ZU).

13. Data carrier signal (DS) which transmits the computer program product (CPP) according to claim 12.
